(19) United States
(12) Patent Application Publication
(10) Pub. No.: US 2008/0100724 A1
(43) Pub. Date: May 1, 2008

(54) Image processing device and imaging device

(76) Inventor: Toshinobu Hatano, Kyoto (JP)

Correspondence Address: MCDERMOTT WILL & EMERY LLP, 600 13TH STREET, NW, WASHINGTON, DC, 20005-3096, US

(21) Appl. No.: 11/976,358

(22) Filed: Oct. 24, 2007

(30) Foreign Application Priority Data
Oct. 25, 2006 (JP) 2006-289500

(51) Int. Cl. H04N 5/235

(52) U.S. Cl. 348/229.1

(57) ABSTRACT

A gain adjustment processor generates first gain-adjusted image data by executing a first gain adjustment suitable for display processing to image data, and further generates second gain-adjusted image data by executing a second gain adjustment suitable for detection of a particular region in the image data to the image data or the first gain-adjusted image data. A particular region detection processor detects the particular region in the image data based on the second gain-adjusted image data.

### BACKGROUND OF THE INVENTION

1. Field of the Invention

The present invention relates to an image processing device installed in a digital camera, a mobile telephone, a personal computer and the like, more specifically to a technology for improving an accuracy in detecting a particular region when a person is imaged and reproduced.

2. Description of the Related Art

In recent years, a digital still camera in which a film and its development can be dispensed with has been booming, and many of mobile telephones available now are provided with a built-in camera. Thus, remarkable improvements have been achieved in speed-up and image quality. When a person is photographed, it is important not only to respond to a motion of the photographic subject but also to cope with camera shake when photographed and to be able to photograph the subject making it unnecessary to recompose the subject between when the focus is obtained and when the subject is photographed. So far was proposed such an imaging device as shown in FIG. 6 in which a particular region such as a person's face in a screen is detected so that the focus is obtained, and the person is imaged with an exposure optimal to the particular region, for example, as recited in No. 2005-318554 of the Japanese Patent Laid-Open.

In the imaging device, an A/D-converted image data (hereinafter, referred to as first image data) is memorized and the first image data is subjected to a predetermined processing so that second image data is generated and memorized. After that, such a particular region as a face is detected from the second image data while an image is being displayed based on the first image data. When the detection of the particular region is completed, necessary information is extracted from the data of a part of the first image data corresponding to the particular region and subjected to processing of auto focus, automatic exposure and white balance (hereinafter, referred to as control processing). In the case of this device, the control processing can immediately follow movements of the person because the particular region is detected from the second image data which is the image data used for the detection of the particular region in photographing sequences.

However, in the above conventional imaging device, though the particular region can be speedily detected, an accuracy in the detection of the particular region is reduced and the particular region thereby cannot be stably detected due to a low contrast resulting from a low-light intensity in the case where a photographic subject is under the condition of the low-light intensity, for example, when the background is dark or a person in the shade due to backlight is photographed. As a result, the control processing becomes unstable, leading consequently to failure in pressing a shutter at the right moment.

### SUMMARY OF THE INVENTION

Therefore, a main object of the present invention is to provide an image processing device capable of obtaining a high accuracy in detection of a particular region in an environment with a low-light intensity.

An image processing device according to the present invention comprises:
a gain adjustment processor for generating a first gain-adjusted image data by executing a first gain adjustment suitable for a display processing to an image data and further generating a second gain-adjusted image data by executing a second gain adjustment suitable for detection of a particular region in the image data to the image data or the first gain-adjusted image data; and
a particular region detection processor for detecting the particular region in the image data based on the second gain-adjusted image data.

The second gain adjustment is independent from the first gain-adjustment. More specifically, the second gain adjustment suitable for the detection of the particular region is executed in such a manner as independent from the first gain adjustment suitable for the display processing. Therefore, even in the particular region with the low-light intensity such as a person's face in the shade at the time of the backlight or in a dark background, the gain adjustment suitable for photographing the particular region with the low-light intensity is executed so as to increase the contrast. As a result, the particular region can be more accurately detected.

As is known from the foregoing description, it is preferable that the particular region be a face region of a person as a photographic subject,
the second gain adjustment be a gain adjustment suitable for the detection of the face region in the image data, and
the particular region detection processor detect the face region in the image data as the particular region.

The gain adjustment processor preferably further executes size reduction processing to the image data at reduction ratios which differ between the first gain adjustment and the second gain adjustment, and appends a digital gain to the second gain-adjusted image data by utilizing a data range of the second gain-adjusted image data enlarged by filtering processing executed along with the size reduction processing. In the size reduction processing, the data is filtered to be thinned, and the data range is thereby enlarged. In the case where the size reduction processing is executed for the detection of the particular region, the enlarged data range is utilized so that the digital gain is appended to the resized image data. As a result, a luminance level of the particular region with the low-light intensity can be easily increased. Any detailed characteristic is not demanded in the filtering processing then executed.

The gain adjustment processor preferably appends a digital gain weighted in a main data range in the particular region to the image data or the first gain-adjusted image data. Accordingly, such a weighted gain adjustment that has a non-linear characteristic, for example, the gamma characteristic or the polygonal-line knee characteristic, is executed when the dynamic range of the image data is made to be substantially equal to an input dynamic range, so that the luminance level of the low-light intensity section can be effectively increased. As a result, the contrast can be accurately increased, and the particular region can be thereby more accurately detected.

The gain adjustment processor preferably further executes the size reduction processing to the image data or the first gain-adjusted image data at reduction ratios which differ between the first gain adjustment and the second gain adjustment, and appends the gain in the second gain adjustment to the image data suitably size reduced for the second gain adjustment.

The image processing device preferably further comprises a memory for the detection of the particular region, wherein the gain adjustment processor comprises:
a first gain adjustment processor for generating a first size reduced gain-adjusted image data by executing the size reduction processing suitable for the display processing and then executing the first gain adjustment to the image data; and
   a second gain adjustment processor for generating a second size reduced gain-adjusted image data by executing the size reduction processing suitable for the detection of the particular region and then executing the second gain adjustment to the first size reduced gain-adjusted image data, and
the memory for the detection of the particular region stores therein the second size reduced gain-adjusted image data, and

the particular region detection processor detects the particular region based on the second size reduced gain-adjusted image data read from the memory for the detection of the particular region.

According to the foregoing constitution, when the second size reduced gain-adjusted image data is generated, the first size reduced gain-adjusted image data is utilized. Then, in the particular region with the low-light intensity such as a person's face in the shade at the time of the backlight or in a dark background, the gain adjustment suitable for photographing the particular region with the low-light intensity is executed so as to increase the contrast in a manner similar to the constitution described earlier. As a result, the particular region can be more accurately detected.

An imaging device according to the present invention comprises:
a memory;
a memory controller for storing image data in the memory; and
the image processing device according to the present invention, wherein

the gain adjustment processor executes the first gain adjustment to the image data read from the memory via the memory controller.

According to the present invention, in the case of a particular region with the low-light intensity such as a person's face region in the shade at the time of the backlight or in a dark background, the particular region can be more accurately detected. Therefore, the control processing such as auto focus, automatic exposure and white balance at person-image-capturing time can be stably operated. Thus, the present invention is significantly useful to quality improvement when the person's photograph is obtained.

### BRIEF DESCRIPTION OF THE DRAWINGS

These and other objects as well as advantages of the invention will become clear by the following description of preferred embodiments of the invention and they will be specified in the claims attached hereto. A number of benefits not recited in this specification will come to the attention of the skilled in the art upon the implementation of the present invention.

FIG. 1 is a block diagram illustrating a constitution of an imaging device according to a preferred embodiment 1 of the present invention.

FIG. 2 is a block diagram illustrating a constitution of an image processing device according to the preferred embodiment 1.

FIG. 3A shows a gamma characteristic which is a non-linear gain characteristic with respect to an inputted image according to the preferred embodiments of the present invention.

FIG. 3B shows is a polygonal-line knee characteristic which is a non-linear gain characteristic with respect to the inputted image according to the preferred embodiments of the present invention.

FIG. 4A is an (first) illustration of a specific example of image processing with respect to a person's image according to the preferred embodiments of the present invention.

FIG. 4B is an (second) illustration of a further specific example of the image processing with respect to the person's image according to the preferred embodiments of the present invention.

FIG. 4c is an (third) illustration of a still further specific example of the image processing with respect to the person's image according to the preferred embodiments of the present invention.

FIG. 5 is a block diagram illustrating a constitution of an image processing device according to a preferred embodiment 2 of the present invention.

FIG. 6 is a block diagram illustrating a constitution of an imaging device according to a conventional technology.

### DETAILED DESCRIPTION OF THE INVENTION

Hereinafter, preferred embodiments of an image processing device according to the present invention are described in detail referring to the drawings.

### Preferred Embodiment 1

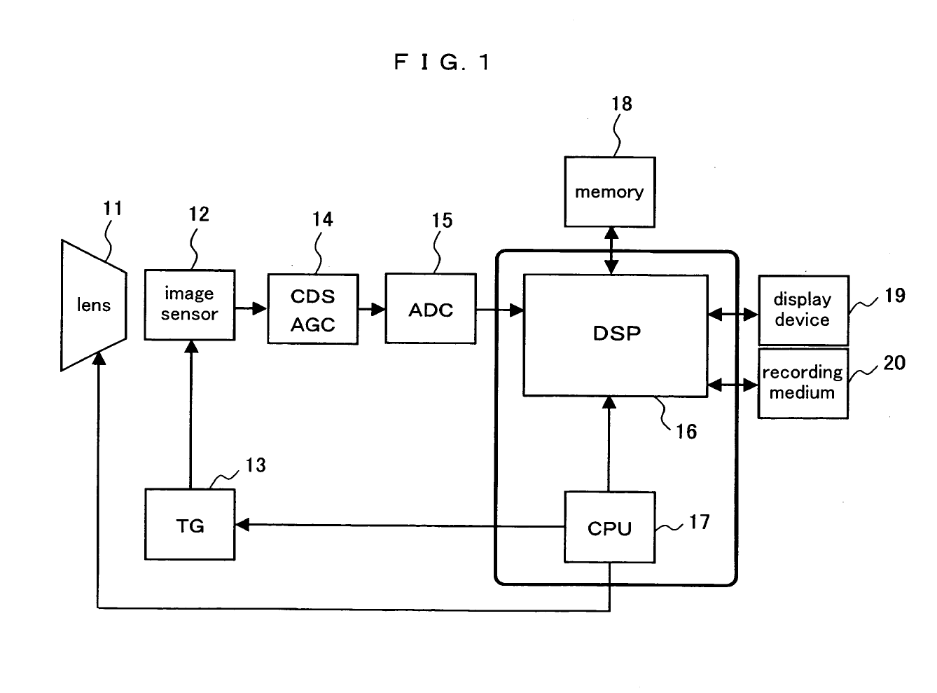

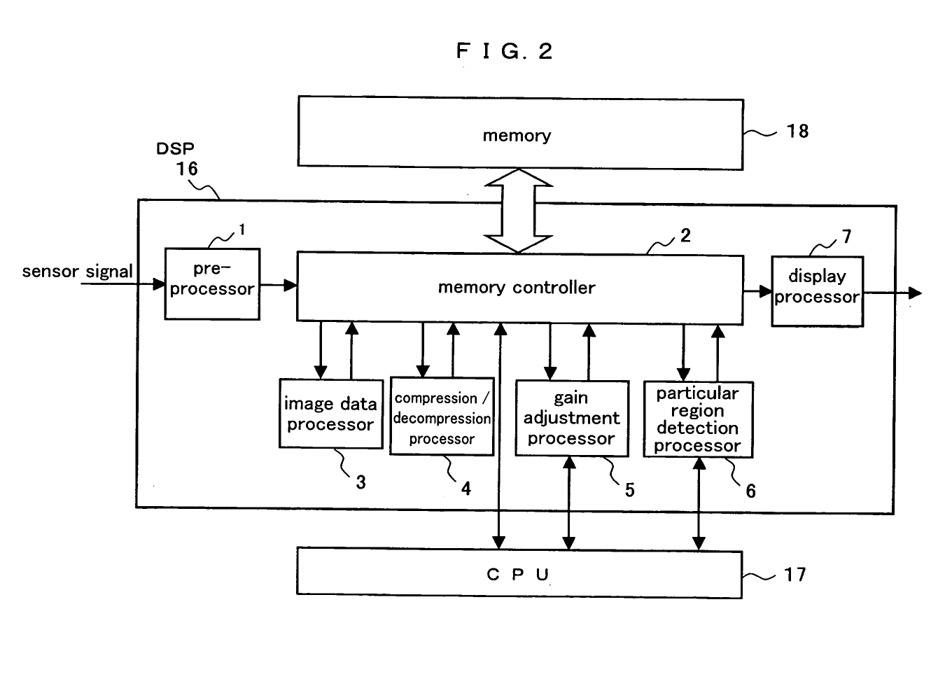

FIG. 1 is a block diagram illustrating a constitution of an imaging device comprising an image processing device according to a preferred embodiment 1 of the present invention. FIG. 2 is a block diagram illustrating a constitution of the image processing device according to the preferred embodiment 1.

First, the imaging device according to the present preferred embodiment is described referring to FIG. 1. Referring to reference numerals shown in FIG. 1, 11 denotes a lens unit including an imaging lens, 12 denotes a two-dimensional image sensor, 13 denotes a timing generator (TG) for generating a drive pulse of the image sensor 12, 14 denotes a CDS/AGC circuit for removing noise of an imaging video signal outputted from the image sensor 12 and controlling a gain, 15 denotes an A/D converter (ADC) for converting an analog video signal into a digital image data, 16 denotes a DSP (digital signal processing circuit) for executing various types of processing (including detection of a particular region) by executing a predetermined program, 17 denotes a CPU (microcomputer) for controlling general system operation of the imaging device using a control program, 18 denotes a memory in which the image data and various types of data are stored, 19 denotes a display device, and 20 denotes a recording medium. The image processing device according to the present preferred embodiment is mounted in the DSP 16.

Next, the operation of the imaging device thus constituted is described. First, typical imaging/recording operation is described. When an imaging light enters the image sensor 12 via the lens in the lens unit 11, an image of a photographic subject is converted into an electrical signal by photo diode and others, and an imaging video signal, which is an analog continuous signal, is generated from the electrical signal based on vertical and horizontal driving control synchronizing with a drive pulse from the timing generator 13 and outputted from the image sensor 12. The imaging video signal, after 1/f noise is appropriately size reduced by a sample hold circuit (CDS) in the CDS/AGC circuit 14, is auto-gain controlled by the CDS/AGC circuit 14, and converted into a digital image data by the A/D converter 15. The generated digital image data is subjected to various types of processing, such as luminance signal processing, color-separation processing, color-matrix processing, data-compression processing, resizing processing and particular region detection, in the A/D converter 15. These types of processing are executed via the memory 18. The digital image data is displayed in the display device 19 after the various types of processing are executed thereto, and recorded in the recording medium 20 by the recording operation.

When the recorded data is reproduced, the digital image data is read from the recording medium 20, decompressed in the case where it is compressed data, resized to have a display size and outputted to the display device 19.

Referring to reference numeral in FIG. 2 which shows details of the DSP 16, 1 denotes a pre-processor for executing pre-processing, such as black-level adjustment and gain adjustment, to the image data fetched into the DSP 16, 2 denotes a memory controller for controlling write/read of the image data between respective processors and the memory 18, 3 denotes an image data processor for executing the luminance-signal processing and color-signal processing to the image data read from the memory 18 via the memory controller 2 and writing the processed image data back into the memory 18 as luminance data and color-difference data (or RGB data), 4 denotes a compression/decompression processor for compressing and decompressing the luminance data and the color-difference data, and 5 denotes a gain adjustment processor for resizing in horizontal and vertical directions and gain-adjusting the original image data read from the memory 18 via the memory controller 2 (combination of the luminance data and color-difference data, or RGB data) and writing the processed image data back into the memory 18. The gain adjustment processor 5 has a function of executing a first gain adjustment processing suitable for the display to the image data read from the memory 18 and a second gain adjustment processing independent from the first gain adjustment and suitable for detection of a particular region to the image data read from the memory 18. The gain adjustment processor 5 executes a linear gain adjustment in the first gain adjustment processing in the normal resizing processing suitable for the display, while executing such a non-linear gain adjustment as gamma characteristic or polygonal-line knee characteristic for increasing a low-light intensity in the second gain adjustment processing in the resizing processing suitable for the detection of the particular region. More specifically, the gain adjustment processor 5 can execute the second gain adjustment suitable for the detection of the particular region independently from the first gain adjustment suitable for the display. Accordingly, the gain adjustment suitable for the low-light intensity can be executed to deal with a particular region with the low-light intensity such as a person's face region in the dark or in the shade at the time of the backlight. A reference numeral 6 denotes a particular region detection processor for detecting the particular region in the image data having a luminance level in a low-light intensity section is to be increased and generated as the image data suitable for the detection of the particular region (second resized gain-adjusted image data). A reference numeral 7 denotes a display processor for transferring the image data suitable for the display and received from the memory controller 2 (first resized gain-adjusted image data) to the display device 19.

Next, the operation of the image processing device according to the present preferred embodiment thus constituted is described. The image data fetched into the DSP 16 is subjected to the pre-processing such as the black-level adjustment and gain adjustment by the pre-processor 1, and the pre-processed image data is written into the memory 18 via the memory controller 2. The image data processor 3 reads the image data written in the memory 18 via the memory controller 2, and executes the luminance-signal processing and color-signal processing thereto to thereby generate the luminance data and color-difference data (or RGB data). Then, the image data processor 3 writes these types of data back into the memory 18 via the memory controller 2.

The gain adjustment controller 5 reads the original image data from the memory 18 via the memory controller 2, and resizes the read data in the horizontal and vertical directions. Then, the gain adjustment controller 5 executes the non-linear gain adjustment for increasing the luminance level of the low-light intensity section to the resulting data in the case where the second resized gain-adjusted image data suitable for the detection of the particular region is generated, and writes the obtained second resized gain-adjusted image data back into the memory 18.

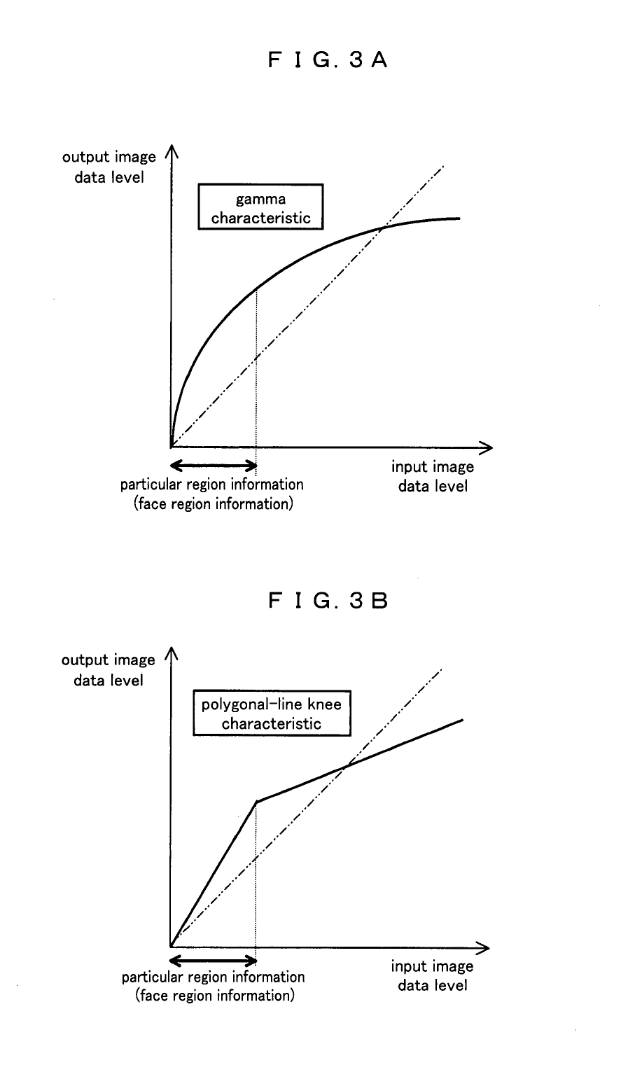

The gain adjustment processor 5 executes low-pass filtering processing in which a targeted pixel and peripheral pixels are multiplied by a coefficient and the two products are added together in the case where the second resized gain-adjusted image data suitable for the detection of the particular region is generated, and then, thins the data. Therefore, the data outputted from the gain adjustment processor 5 has a data range larger than that of the inputted data. In the normal resizing processing (first resizing processing suitable for the display), the processed data is multiplied by a coefficient X (0<X<1) so that an output dynamic range can be equal to an input dynamic range. As a result, the luminance is equal on the input and output sides in the normal resizing processing when the size is reduced. In the case of the second resizing processing suitable for the detection of the particular region, a gain adjustment having the non-linear characteristic that increases the luminance level of the low-light intensity section is executed to the above-described extended data range. As a result, the dynamic range of the output image data is caused to be substantially equal to the dynamic range of the input image data. More specifically, the gain adjustment having the gamma characteristic shown in FIG. 3A or the polygonal-line knee characteristic shown in FIG. 3B is executed, so that the luminance level of the low-light intensity section is increased.

Further, the particular region detection processor 6 reads the second resized gain-adjusted image data from the memory 18 via the memory controller 2, and detects information such as a position, a dimension, a tilt and the like of the particular region (face region or the like). Then, the particular region detection processor 6 executes the control processing such as auto focus, automatic exposure and white balance at image-capturing time to the read image data based on the obtained information.

When the image data is generated for the display, the gain adjustment processor 5 executes the normal resizing processing. More specifically, the gain adjustment processor 5 horizontally and vertically resizes data in a region which is an entire surface of the image data so that the data is resized to have a size suitable for the display, and linearly gain-adjusts the resized image data. Then, the gain adjustment processor 5 outputs the obtained first resized gain-adjusted image data to the display processor 7.

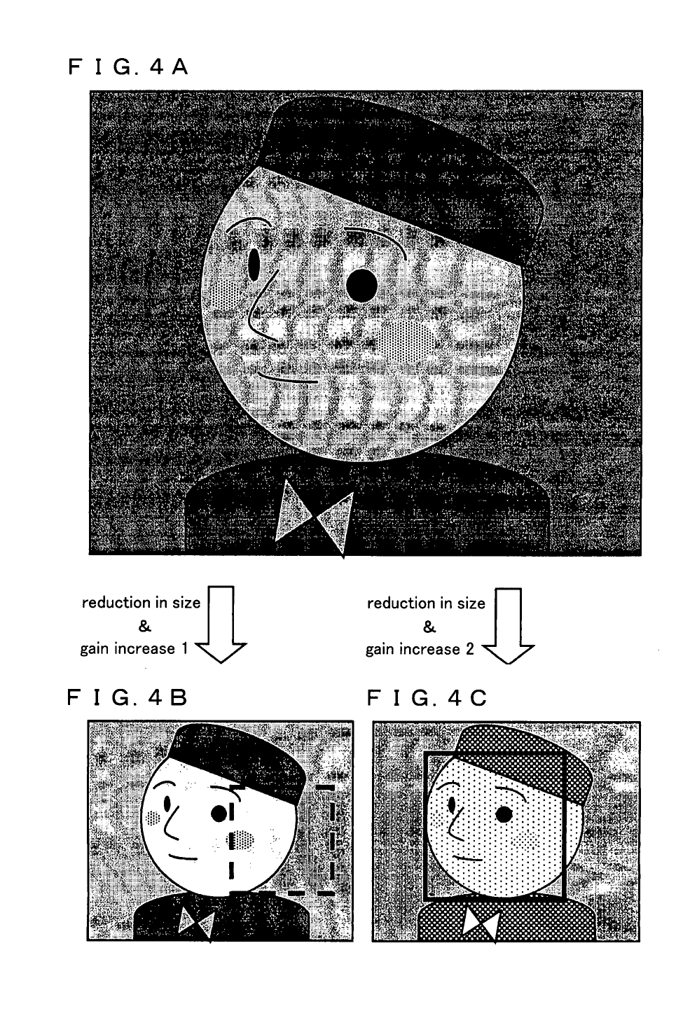

Referring to FIGS. 4A-4C is described a specific example of the image processing executed to a person's image data by the gain adjustment processor 5. In the original image data shown in FIG. 4A, the person's image data was obtained under the condition of a low-light intensity. In this case, the luminance level of the particular region (face region) is low, and the contrast of the image data needed to detect the particular region is also low. When the particular region is detected in such a state, the detection cannot be accurately performed and thereby becomes unstable.

It is necessary to control the first resized gain-adjusted image data suitable for the display so that a visually natural image can be obtained. For that purpose, the gain adjustment processor 5 executes the normal resizing gain adjustment processing in which the gain adjustment is linear as a first resizing gain adjustment processing as shown in FIG. 4B. Therefore, this processing does not include such a correction that only the contrast of the particular region is emphasized.

On the other hand, when the second resized gain-adjusted image data suitable for the detection of the particular region is generated, the gain adjustment processor 5 executes the non-linear gain adjustment processing in which the data range of the particular region is extended as a second resizing gain adjustment processing as shown in FIG. 4C. At the time, when the gain is acutely increased, an S/N ratio drops. However, the detection can achieve a higher accuracy because the basic algorithm of the detection of the particular region is for the removal of a high-frequency component including noise. As a result, the particular region can be stably detected with increasing contrast despite the low-light intensity.

As described, according to the present preferred embodiment, the gain adjustment processor 5 executes the second resizing gain adjustment processing optimized for the detection of the particular region separately from the first resizing gain adjustment processing optimized for the display. Accordingly, the gain is increased while the input dynamic range is secured in the particular region with the low-light intensity. Therefore, the particular region can be more accurately detected, and the control processing such as the auto focus, automatic exposure and white balance at image-capturing time can be executed in a stable manner.

### Preferred Embodiment 2

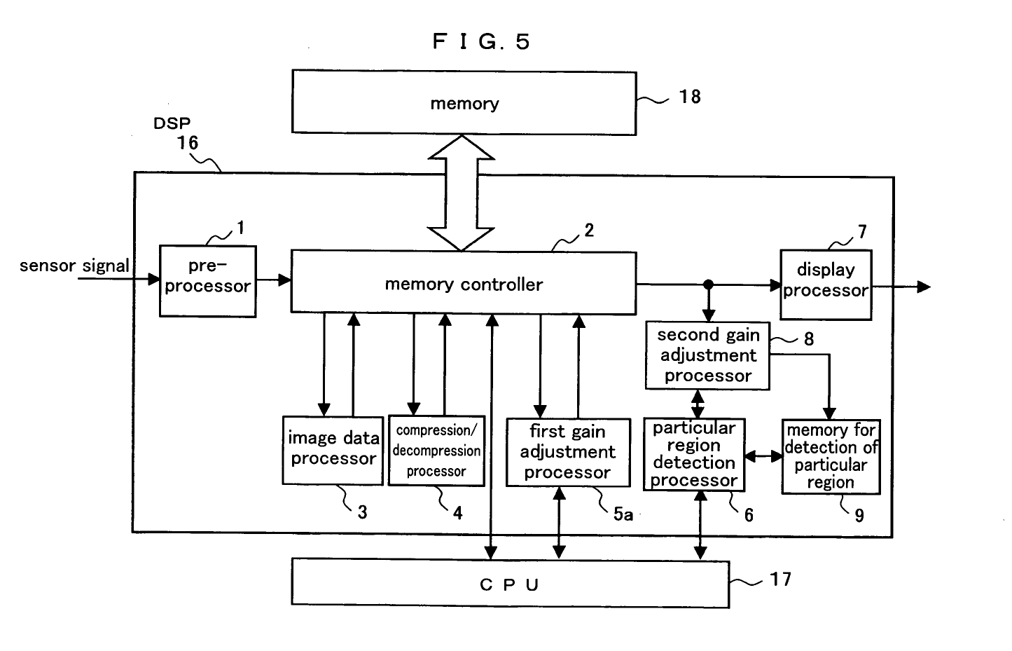

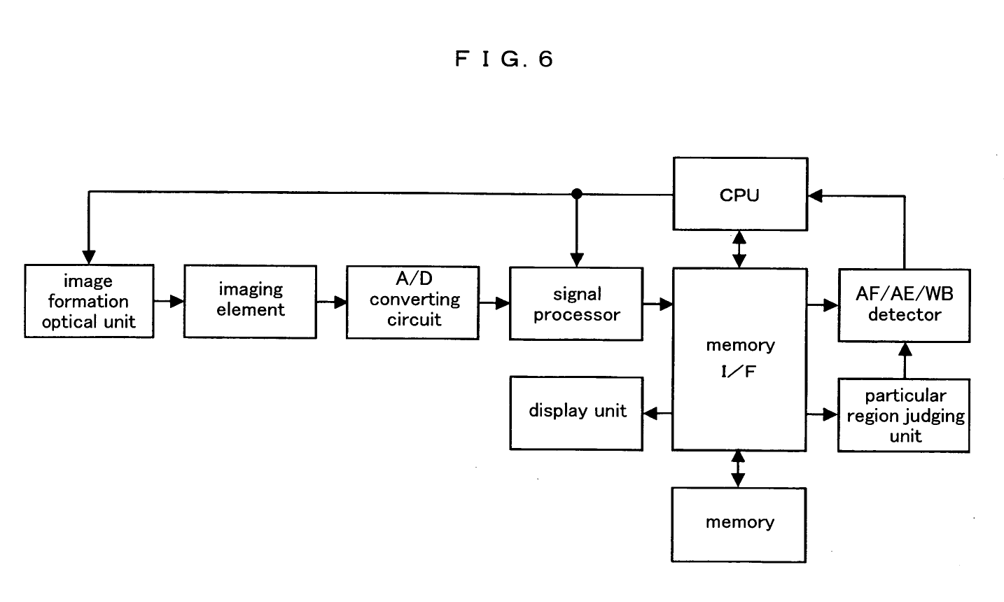

FIG. 5 is a block diagram illustrating a constitution of an image processing device according to a preferred embodiment 2 of the present invention. The same reference numerals as those shown in FIG. 1 according to the preferred embodiment 1 denote the same components. The present preferred embodiment is characterized in that the resized data for the display is used as the input image data for the detection. In FIG. 5, 5a denotes a first gain adjustment processor for generating the first resized gain-adjusted image data by executing the size reduction processing and the first gain adjustment suitable for the display to the image data read from the memory 18 via the memory controller 2. 8 denotes a second gain adjustment processor for generating the second resized gain-adjusted image data by executing the size reduction processing and the second gain adjustment suitable for the detection of the particular region to the first resized gain-adjusted image data transmitted from the memory controller 2 to the display processor 7. 9 denotes a memory for the detection of the particular region in which the second resized gain-adjusted image data generated by the second gain adjustment processor 8 is stored. In the present preferred embodiment, the particular region detection processor 6 detects the particular region based on the second resized gain-adjusted image data read from the memory for the detection of the particular region 9.

In a manner similar to the preferred embodiment 1, the high-frequency component including noise is removed in the basic algorithm of the detection of the particular region according to the present preferred embodiment. Therefore, in the case where the gain of the data is increased in order to increase the contrast when the second resized gain-adjusted image data is generated from the first resized gain-adjusted image data, the S/N ratio in the image is not any further size reduced, and therefore the contrast in the second resized gain-adjusted image data is increased. As a result, the particular region can be more accurately detected and can be stably detected despite the low-light intensity.

When the gain of the input data for the detection of the particular region is increased, the low-pass filter output is used when the size is reduced in the foregoing preferred embodiment; however, the gain can be simply increased before the detection of the particular region.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. An image processing device comprising:
a gain adjustment processor for generating a first gain-adjusted image data by executing a first gain adjustment suitable for a display processing to an image data and further generating a second gain-adjusted image data by executing a second gain adjustment suitable for detection of a particular region in the image data to the image data or the first gain-adjusted image data; and
a particular region detection processor for detecting the particular region in the image data based on the second gain-adjusted image data.

2. The image processing device as claimed in claim 1, wherein
the particular region is a face region of a person as a photographic subject,
the second gain adjustment is a gain adjustment suitable for the detection of the face region of the person as the photographic subject in the image data, and
the particular region detection processor detects the face region in the image data as the particular region.

3. The image processing device as claimed in claim 1, wherein
the gain adjustment processor further executes a size reduction processing to the image data at reduction ratios which differ between the first gain adjustment and the second gain adjustment, and appends a digital gain to the second gain-adjusted image data by utilizing a data range of the second gain-adjusted image data enlarged by filtering processing executed along with the size reduction processing.

4. The image processing device as claimed in claim 2, wherein
the gain adjustment processor appends a digital gain weighted in a main data range in the particular region to the image data or the first gain-adjusted image data.

5. The image processing device as claimed in claim 1, wherein
the gain adjustment processor further executes size reduction processing to the image data or the first gain-adjusted image data at reduction ratios which differ between the first gain adjustment and the second gain adjustment, and appends the gain in the second gain adjustment to the image data suitably size reduced for the second gain adjustment.

6. The image processing device as claimed in claim 4, wherein
the gain adjustment processor appends a digital gain weighted in a main data range in the particular region to the image data or the first gain-adjusted image data.

7. The image processing device as claimed in claim 4, further comprising a memory for the detection of the particular region, wherein the gain adjustment processor comprises:
a first gain adjustment processor for generating a first resized gain-adjusted image data by executing the size reduction processing suitable for the display processing and then executing the first gain adjustment to the image data; and
a second gain adjustment processor for generating a second resized gain-adjusted image data by executing the size reduction processing suitable for the detection of the particular region and then executing the second gain adjustment to the first size reduced gain-adjusted image data, and
the memory for the detection of the particular region stores therein the second resized gain-adjusted image data, and
the particular region detection processor detects the particular region based on the second resized gain-adjusted image data read from the memory for the detection of the particular region.

8. An imaging device comprising:
a memory;
a memory controller for storing image data in the memory; and
the image processing device as claimed in claim 1, wherein
the gain adjustment processor executes the first gain adjustment to the image data read from the memory via the memory controller.
